(19) United States
(12) Patent Application Publication
(10) Pub. No.: US 2007/0036321 A1
(43) Pub. Date: Feb. 15, 2007

(54) Service discovery

(76) Inventor: Thomas Busse, Erkrath (DE)

Correspondence Address: HARRINGTON & SMITH, LLP, 4 RESEARCH DRIVE, SHELTON, CT, 06484-6212, US

(21) Appl. No.: 10/575,536

(22) PCT Filed: Oct. 28, 2004
(86) PCT No.: PCT/IB04/03664

§ 371 Date: Apr. 11, 2006

(30) Foreign Application Priority Data
Oct. 31, 2003 (GB) 0325457.0

(51) Int. Cl. H04M 3/42

(52) U.S. Cl. 379/211.02

(57) ABSTRACT

A method of discovering the service offered by a second device using a first device, including the first device makes a service search request; the second device receives the service search request and sends at least a first attribute identifying a user-friendly name; and the first device receives the first attribute, obtains a user friendly name from the received first attribute and displays the user friendly name.

### FIELD OF THE INVENTION

Embodiments of the present invention relate to methods, devices, systems and software for discovering the service offered by one device to another.

### BACKGROUND TO THE INVENTION

When a user of a first Bluetooth device wishes to obtain access to a service offered by a local device, the first Bluetooth device initiates an inquiry procedure to discover which devices are in range. The Bluetooth devices within range respond with an inquiry response including their Bluetooth Device Address. The first Bluetooth device then makes a connection, in turn, to each of the devices that are in range and uses the connection to request the device's user-friendly name using the ‘Name Request’ procedure. The first Bluetooth device then starts the Service Discovery Protocol (SDP). It interrogates the other devices to determine if any of them are candidates for providing a required service. The other devices that do provide the required service reply with an indication of the services that are provided and the protocols that are used. The services provided are indicated using service names. The list of candidate devices is then displayed to the user of the first device. The user-friendly names obtained via the Name Request are used to identify the candidate devices and the user can consequently make an informed selection of which device should be used to provide the required service.

US2003/0158952 discloses a process similar to the above described Device Discovery Protocol (SDP) that sends in reply to the SDP interrogation not only an indication of a service name, but also an indication of a virtual communications port.

A problem arises because the process of connecting to each candidate device to request its user-friendly name (the ‘Name Request’ procedure) is time consuming. Each connection requires a paging procedure which can take up to 2.5 seconds.

### BRIEF DESCRIPTION OF THE INVENTION

It would therefore be desirable to reduce the time taken to acquire the user-friendly names of candidate devices.

However, finding a solution to this problem is not a simple matter as the solution must be substantially compliant with the Bluetooth Specification.

According to one embodiment of the invention there is provided a method of discovering the service offered by a second device using a first device, comprising: the first device makes a service search request; the second device receives the service search request and sends at least a first attribute identifying a user-friendly name; and the first device receives the first attribute, obtains a user friendly name from the received first attribute and displays the user friendly name.

According to another embodiment of the invention there is provided a device operable as a host of an interactive application comprising: means for sending a message to an other device to determine whether that other device offers a service; means for receiving a plurality of attributes in response to the message from the other device and determining a user friendly name identifying the other device from the received plurality of attributes.

According to another embodiment of the invention there is provided a method of discovering the service offered by a second device using a first device, comprising: the first device makes a service search request to the second device; the first device receives, from the second device, a plurality of attributes including a first attribute identifying a user-friendly name; and the first device, obtains the user friendly name from the received first attribute and displays the user friendly name.

According to a further embodiment of the invention there is provided a device operable as a client of an interactive application comprising: means for creating a service record, associated with the interactive application, that includes a user friendly name identifying the device or its user.

According to another embodiment of the invention there is provided a device operable as a client of an interactive application comprising: means for creating a service record, associated with the interactive application, that includes a user definable name.

According to a further embodiment of the invention there is provided a device operable to send a user-friendly device name during service discovery protocol.

According to another embodiment of the invention there is provided a device operable to receive a user-friendly device name during service discovery protocol.

According to a further embodiment of the invention there is provided a computer program which when loaded into a processor enables an interactive multi-user application, the computer program comprising: means for defining a first service record; means for defining a first attribute; and means operable to include a user-friendly device name as a first attribute of a first service record for storage in a database.

According to another embodiment of the invention there is provided a computer program which when loaded into a processor enables an interactive multi-user application, the computer program comprising: means for defining a first service record; means for defining a first attribute; and means operable to obtain a user-friendly device name from a first attribute of a first service record received from another device.

According to a further embodiment of the invention there is provided a computer program which when loaded into a processor enables an interactive multi-user application, the computer program comprising: means for defining a first service record; means for defining a first attribute; means operable, during a client mode, to include a user-friendly device name as a first attribute of a first service record for storage in a database; and means operable, during a host mode, to obtain a user-friendly device name from the first attribute of service record received from another device.

Various other embodiments of the invention are defined in the appended claims.

Embodiments of the invention combine service discovery with name request without introducing a new procedure. Thus two formerly separate procedures (Service Discovery and Name Request) are combined into a single procedure (Service Discovery).

The whole selection process can be speeded up by approx. 2.5 seconds per device.

### DETAILED DESCRIPTION OF EMBODIMENT(S) OF THE INVENTION

For a better understanding of the present invention reference will now be made by way of example only to the accompanying drawings in which:

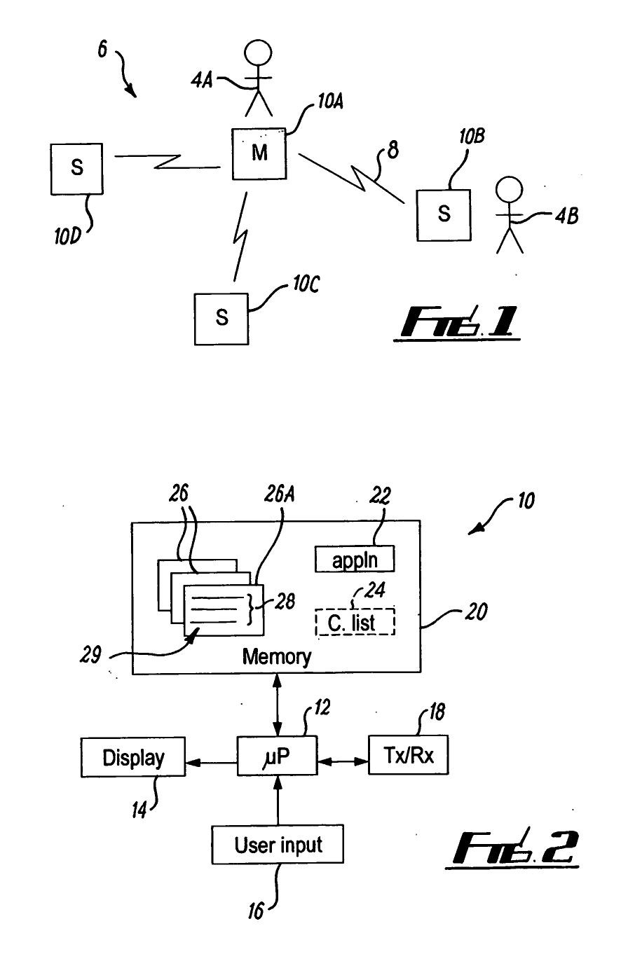

FIG. 1 illustrates a Bluetooth piconet including a master device (M) and slave devices (S);

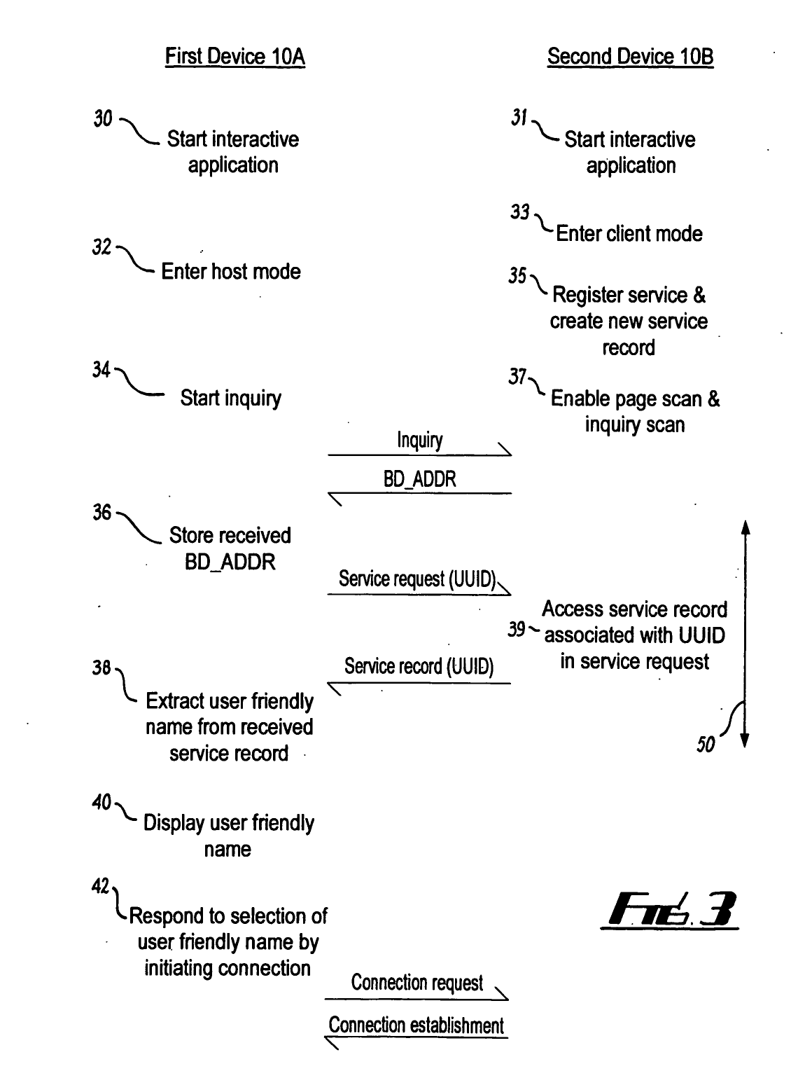

FIG. 2 illustrates a device for use in the piconet;

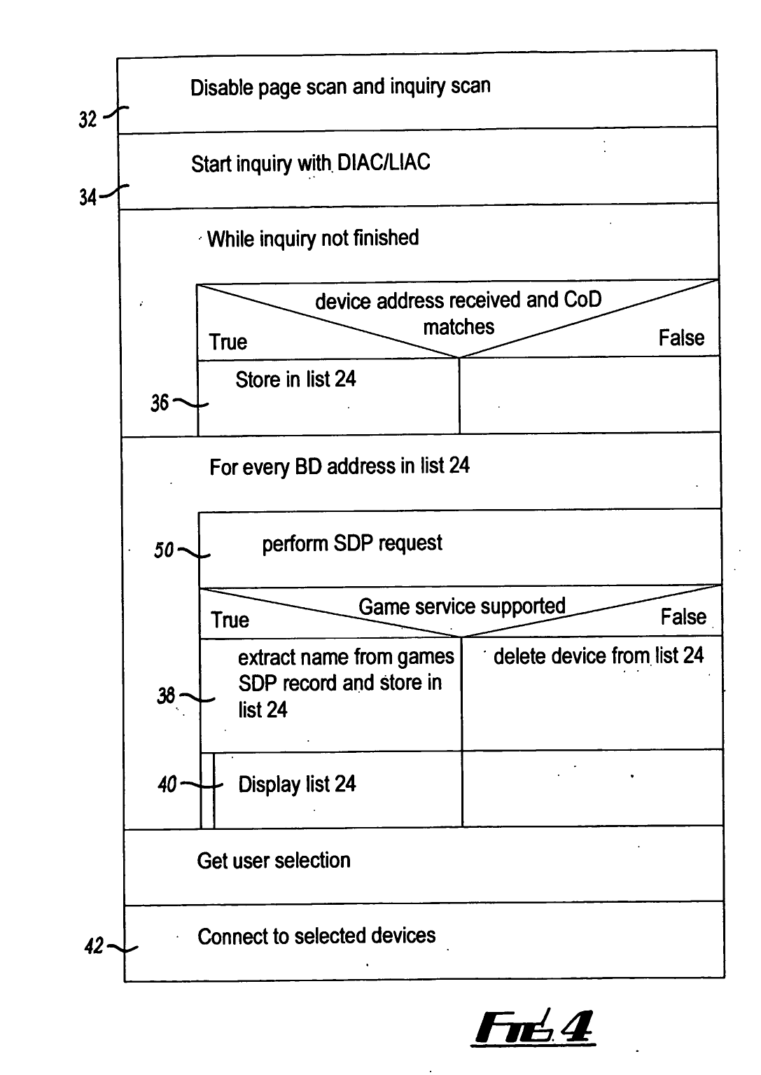

FIG. 3 illustrates a method for carrying out one embodiment of the invention;

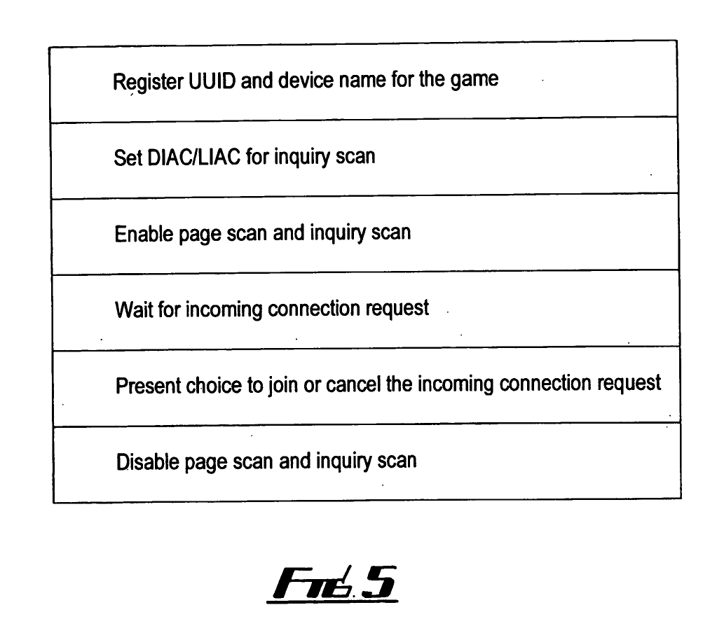

FIG. 4 illustrates the process that occurs in the Application Host; and

FIG. 5 illustrates the process that occurs in the Application Client.

FIG. 1 illustrates a Bluetooth piconet 6 including a master device (M) 10A and slave devices (S) 10B, 10C, 10D. The master device 10A forms the piconet 6 by performing an inquiry procedure to obtain the Bluetooth device addresses of local Bluetooth devices. The master device uses the Bluetooth addresses to page the devices it intends to form a piconet with. The page response made by those devices is then used to establish a connection between the master device and the slaves.

The master device may only wish to form a piconet 6 with Slave devices that provide particular services, for example, if an interactive game is to be played using the piconet then the master device will only seek to include devices that have the capability of participating in the interactive game within the piconet 6. The Service Discovery Protocol is used by the master, after the inquiry procedure to identify those in-range Bluetooth device that provide a desired service such as supporting the interactive game. Embodiments of the invention allow those devices that provide the desired service to be identified using a user-friendly name at the end of the service discovery protocol without the need or a separate name request process. Thus the user of the master is able to choose who to include in the piconet and, may for example include only his friends within the piconet if it is for playing an interactive game.

The users of interactive applications e.g. multi-player game applications, chat over Bluetooth etc and applications with real-time elements are particularly sensitive to latencies in initiating the application. Embodiments of the invention therefore are particularly useful in setting up a multi-user interactive application. However, the invention may be used in conjunction with other applications.

In a multi-user interactive scenario, each user has a mobile device such as a mobile telephone and each device typically runs the same interactive application software. Generally any device can act as the host of the application.

The interactive application software defines a special service record/UUID unique to that application and defines an attribute within that special service record that is used, in an application client, for storing the user-friendly name of the client device or its user.

FIG. 2 illustrates a device 10 that is suitable for use as any one of devices 10A, 10B, 10C or 10D in FIG. 1. The device 10 is typically a hand-portable mobile device, but does not have to be. The device 10 comprises: a processor 12, a display 14, a user input device 16 such as a keypad, joystick etc, a low power radio frequency transceiver 18 and a memory 20. The processor is connected to receive input commands from the user input device 16 and provide output commands to the display 14 for controlling the image displayed. The processor 12 is also connected to provide data to and receive data from the radio transceiver 18 and to read from and write to the memory 20.

The memory 20 is used for storing the interactive software application 22. If the device 10 operates as an application host then the memory is also used to store a candidate list 24. If the device 10 operates as an application client then the memory is also used to store a service records 26.

FIG. 3 illustrates a method for carrying out one embodiment of the invention. In this embodiment, a first device 10A controlled by a first user 4A creates a connection 8 with a second device 10B controlled by a second user so that the first and second users 4A, 4B can participate in an interactive application.

Initialising Application Host

1) At step 30, a first user 4A of a first Bluetooth device 10A starts the interactive application software.

2) The first user 4A selects option “serve as Application Host”

3) At step 32, the interactive application software enters a Host mode and the first device 10A, which is now an Application Host, disables page scan and inquiry scan.

4) At step 34, the Application Host starts the Inquiry procedure. During Inquiry, the Application Host 10A stores the received Bluetooth Device Addresses (BD_ADDR) as a candidate list 24 as illustrated at step 36.

Initialising Application Client

a) At step 31, a second user 4B of a second Bluetooth device 10B starts the interactive application software 22. The interactive application software enters a Client mode at step 33 and the second device 10B, is now an Application Client.

b) At step 35, the Application Client 10B registers the service corresponding to the interactive software application 22. The Application Client operates 10B as a “Service Discovery Protocol (SDP) server”. SDP is described in “Specification of the Bluetooth System”, v1.0B, Dec. 1, 1999, Part E, the contents of which are herewith incorporated by reference.

The “SDP server” 10B stores in memory 20 a database that includes service records 26. A new service record 26A is created for the interactive application.

The service record 26A is associated with the UUID defined by the software of the application.

The service record 29 includes a number of attributes 28. The ServiceClassIDList attribute identifies the type of service represented by the service record. It lists the classes of which the service is an instance using UUIDs. Each UUID represents the service class that a given service record conforms to. Another attribute 29 is for defining a user friendly name identifying the second device 10B or the second user 4B. The Application Client 10B may allow a user 4B to specify the user friendly name via the user input device 16. As a default the Bluetooth device name may be used. The particular attribute 29 that contains the user friendly name is defined by the application software and is consequently predetermined.

This defined attribute 29 may be one that is normally used for another purpose but in this situation is used to store the user friendly name. For example, the “ServiceName” attribute may be used. The ServiceName attribute is generally in every service record so it can easily be re-used to store the user-friendly name. Alternatively, the defined attribute may be a newly defined additional attribute.

The “SDP server” 10B will send attributes from a service record to any “SDP client” that searches for a service using the UUID associated with that service record via its ServiceClassIDList attribute.

As the Application Host 10A and Application Client 10B are controlled by the same software, they will both know the defined UUID and the defined attribute 29.

e) The Application client 10B then enables and performs page scan and inquiry scan at step 37. The Application Client 10B will respond to any incoming inquiry.

Service Discovery Protocol

The Application Client 10B replies to the inquiry of the Application Host 10A. Other Application Clients may also reply.

6) Then, the Application Host 10A operates as an “SDP client” and performs 50 Service Discovery Protocol (SDP) for each BD_ADDR in the candidate list 24 to discover a service corresponding to the interactive application in the nearby devices. The Application Host 10A searches using a service search pattern that includes the unique UUID of the interactive application.

The Application Client 10B operating as an “SDP server”, responds to this search at step 39 by accessing and sending the service record 26A for the interactive application i.e. all the attributes . This service record 26A includes the defined attribute 29 that specifies the user friendly name. The Application Client 10B then waits for an incoming connection request.

The SDP procedure 50 in the preceding paragraphs corresponds to a ServiceSearchAttribute transaction in which the SDP client sends an SDP_ServiceSearchAttributeRequest message that includes a ServiceSearchPattern parameter that includes the UUID of the interactive application and a AttributeIDList parameter that specifies all attributes and the SDP server replies with a SDP_ServiceSearchAttributeResponse message that includes all the attributes. However, it is possible for the SDP_ServiceSearchAttributeRequest message to specify particular attributes using the AttributeIDList parameter and in this case only the specified attributes are sent by the SDP server to the SDP client in the SDP_ServiceSearchAttributeResponse message.

The invention may also be used when a ServiceSearch transaction and a ServiceAttribute transaction are used instead of a single ServiceSearchAttribute transaction. In the ServiceSearch transaction, the SDP client sends an SDP_ServiceSearchRequest message that includes a ServiceSearchPattern that includes the UUID of the interactive application. The SDP server responds by sending an SDP_ServiceSearchResponse message that identifies the service record for the interactive application using a service record handle. Then in the ServiceAttribute transaction, the SDP client sends a SDP_ServiceAttributeRequest that identifies the required service record using a service record handle and the attributes required using the AttributeIDList. The SDP server sends a SDP_ServiceAttributeResponse that includes the requested attributes of the identified record.

The Application Host 10A receives the attributes 28 of the service record 26A from a remote device only if that device supports the interactive application. So, if the Application Host receives the attributes of a service record 26A from a particular remote device during SDP procedure 50 it knows that particular remote device offers the service (the interactive application). If the interactive service is not supported by a remote device, the remote device is deleted from the candidate list 24. If the interactive service is supported by the remote device, then at step 38 the ‘user friendly name’ is extracted from the defined attribute 29 of the received attributes and stored in the candidate list 24.

The Application Host displays in display 14 the revised candidate list 24 of the ‘user friendly names’ of devices that support the interactive application (40). The first user selects the device(s) that are to be involved in the interactive software application by selecting the user friendly name(s) that are to join the interactive software application.

A ‘user friendly’ name can be displayed as soon as it is received, allowing the user to select a device for the service before the names of all the devices have been received, alternatively, the list of user friendly names may be displayed after all the user friendly names have been received.

The first device then connects to the selected devices (42). The user of these devices are presented with the option of joining the interactive application.

The first user and the users of the connected devices then operate the interactive application software e.g. they may play a multi-user game or participate in ‘chat’.

The process that occurs at the application host is illustrated in more detail in FIG. 4. The process that occurs at the application client is illustrated in more detail in FIG. 5.

The interactive software application 22 is a computer program comprising computer program instructions that control the operation of the device 10 when loaded into the processor 12. The computer program, when controlling the device 10 to operate as an Application Client 10B, provides for the creation of a new service record for the application that includes the user-friendly name of the device/user in a predetermined attribute 29 and for the user specification of the user-friendly name. The computer program, when controlling the device 10 to operate as an Application Host 10A, provides for the creation of a new service record for the creation of a request for the user-friendly name attribute 29 during SDP, obtaining the user friendly name from the attributes received in reply and displaying a candidate list 24 using user-friendly names.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.”

1. A method for discovering the service offered by a second device using a first device, comprising:
the first device makes a service search request;
the second device receives the service search request and sends at least a first attribute identifying a user-friendly name; and
the first device receives the first attribute, obtains a user friendly name from the received first attribute and displays the user friendly name.

2. A method as claimed in claim 1, wherein the first device is an “SDP client” and the second device is an “SDP server”.

3. A method as claimed in claim 1, wherein the first device is an Application Host and the second device is Application Client.

4. A method as claimed in claim 1, wherein the service search request is a request relating to a first service record stored in a database of the second device.

5. A method as claimed in claim 4, wherein the second device sends the attributes of the requested first service record.

6. A device operable as a host of an interactive application comprising:
means for sending a message to an other device to determine whether that other device offers a service; and
means for receiving a plurality of attributes in response to the message from the other device and determining a user friendly name identifying the other device from the received plurality of attributes.

7. A method of discovering the service offered by a second device using a first device, comprising:
the first device makes a service search request to the second device;
the first device receives, from the second device, a plurality of attributes including a first attribute identifying a user-friendly name; and
the first device, obtains the user friendly name from the received first attribute and displays the user friendly name.

8. A device operable as a client of an interactive application comprising:
means for creating a service record, associated with the interactive application, that includes a user friendly name identifying the device or its user

9. A device as claimed in claim 8, wherein the service record further comprises a second attribute identifying a service class.

10. A device operable as a client of an interactive application comprising:
means for creating a service record, associated with the interactive application, that includes a user definable name.

11. A device as claimed in claim 10, wherein the service record further comprises a second attribute identifying a service class.

12. A device operable to send a user-friendly device name during service discovery protocol.

13. A device operable to receive a user-friendly device name during service discovery protocol.

14. A computer program which when loaded into a processor enables an interactive multi-user application, the computer program comprising:
means for defining a first service record;
means for defining a first attribute; and
means operable to include a user-friendly device name as a first attribute of a first service record for storage in a database.

15. A computer program which when loaded into a processor enables an interactive multi-user application, the computer program comprising:
means for defining a first service record;
means for defining a first attribute; and
means operable to obtain a user-friendly device name from a first attribute of a first service record received from another device.

16. A computer program which when loaded into a processor enables an interactive multi-user application, the computer program comprising:
means for defining a first service record;
means for defining a first attribute;
means operable, during a client mode, to include a user-friendly device name as a first attribute of a first service record for storage in a database; and
means operable, during a host mode, to obtain a user-friendly device name from the first attribute of service record received from another device.

17. (canceled)

18. (canceled)
